(19) United States
(12) Patent Application Publication
(10) Pub. No.: US 2006/0005519 A1
(43) Pub. Date: Jan. 12, 2006

(54) Hedge breaching device

(75) Inventor: Kewal K. Chopra, Sterling Heights, MI (US)

Correspondence Address: U.S. ARMY TACOM;ATTN: AMSTA-LP/281, 6501 E. 11 MILE RD., WARREN, MI, 48397-5000, US

(73) Assignee: The United States of America as represented by the Secretary of the Army, Washington, DC (US)

(21) Appl. No.: 10/885,389

(22) Filed: Jul. 7, 2004

(51) Int. Cl. A01D 82/00

(52) U.S. Cl. 56/1

(57) ABSTRACT

A hedge-breaching device for military vehicles has shaped arms holding a dentate cutting blade. The hedge breacher has an open mesh structure which will cause the debris to be deposited in furrows as the breacher moves forward and further has a leveling device that will dress the debris so as to provide a somewhat leveler terrain over which a person on foot can move easily.

### GOVERNMENT INTEREST

This invention may be made, used, and licensed by or for the United States Government without payment to me of any royalty.

### BACKGROUND OF THE INVENTION

Military vehicles frequently travel cross-country as part of exercises and/or actual battle conditions. When so engaged they frequently encounter obstacles which must be surmounted. One example of a problem frequently encountered by military forces is the hedgerows located across countrysides in many places in the world. Such hedgerows are the result of local farmers removing stones from fields and placing the stones at the edge of their fields, this removes the stones from interfering with normal farming operations. In addition frequently brush, brambles or other low growing shrubs are added or row naturally to create a barrier for cattle and other livestock on the farm. Such hedgerows frequently will remain undisturbed for many years and become dense and impenetrable not only to persons and cattle but also to vehicles. Further, in the case of military vehicles, as they traverse over a hedgerow the underside of the vehicle, that is most vulnerable, will be momentarily exposed to an enemy. This allows an enemy combatant an open shot at the underside and therefore the most vulnerable part of the vehicle endangering the vehicle occupants and compromising the mission.

In World War II the allies discovered that in traversing the countryside the hedgerows they encountered constituted a substantial obstacle even to tanks and many vehicles were disabled by the enemy when they attempted to climb over the hedgerows. As a solution to this problem, a device known as “Culin hedgerow cutter” was developed by a soldier and proved successful at removing hedgerows as a vehicular obstacle.

However, the device, which was developed while allowing breaching of the hedges, left a tangled mass of debris. Because the device merely cut the brush and pushed aside whenever stones were present the resulting pile of debris made it difficult for soldiers on foot to follow behind a vehicle pushing the cutter. One of the purposes of military vehicles, particularly large armored vehicles is to provide a cleared pathway and shelter for soldiers moving on foot around the vehicle. Thus the prior art cutter and similar devices do not provide a suitable pathway for infantry soldiers who were following the vehicle.

One example of a commercial brush clearing apparatus is found in U.S. Pat. No. 4,180,108. This invention relates to a blade designed to be pushed ahead of a tractor to clear brush and trees. The device has a planar cutting assembly in the form of a triangular blade structure wherein opposite surfaces of the blade present a cutting edge with the third side of the blade being mounted on the front of a tractor. The device is disposed essentially horizontal to the ground with the cutting edges outboard. The cutting edges have a plurality of teeth and the blade further has a beveled portion adjacent the leading edge of each tooth to provide a self-clearing function.

Both the prior art devices described above result in a path which is cleared of standing brush and the like but which will still in an uneven and tangled mass for traverse by individuals on foot.

The hedgerow clearing device of the present invention not only cuts any brush which forms a part of hedgerow or similar obstacle but it will also move rocks ad other solid debris that may be present. Because of the invention's structure, it also levels the debris formed to a state that can be more easily traversed by foot soldiers. This will result in less stress on the troops and a faster traverse of a particular obstacle decreasing the soldier's exposure time to enemy fire and increasing their chance of survival.

### SUMMARY OF THE INVENTION

The present invention is a hedge-breaching device designed to be mounted on a military vehicle, either combat or tactical. The device has at least two and possibly more, brackets which are be attached to corresponding mounting points or bosses on a particular vehicle. From each of the brackets an arm extends outward from the front of the vehicle with a first section of the arm being disposed at the level of the bosses and extending approximately parallel to the ground over which the vehicle is traveling. At the end of the first section distal the vehicle, a second section of the arm is attached to the first section at an oblique angle. The second section will depend downward towards the ambient terrain. A third section of the arm will extend outward from the second section parallel to the ground but at a position relatively closer to the ground than the first arm. The level of the third section above the terrain can be thought of as the working height.

A dentate cutting bar is attached to the free ends of the arm's third section. To provide a cutting means which can be pushed into and through a hedgerow. A leveling roller is attached to and depends from the first section of the arms and between the vehicle and the dentate cutting bar. After the brush has been cleared the roller will flatten the brush resulting in a pathway of a more uniform texture and height providing a pathway more amenable to persons on foot.

### BRIEF DESCRIPTION OF THE DRAWINGS

Referring to the accompanying drawing:

FIG. 1 s a perspective view of one embodiment of this invention;

FIG. 2 is a perspective view of a tactical vehicle bumper suitable for use with this invention; and

The Prior Art Figure is perspective view of the World War II device.

### DESCRIPTION OF THE PREFERRED EMBODIMENTS

Referring to the accompanying drawing wherein like numerals referred to like parts, the prior art figure shows a device having a pair of mounting brackets located at the rear of the device which can be attached to corresponding bosses extending outward from the front of a vehicle. The particular device shown is constructed so as to be readily attached to the front of a Sherman tank that had such attachment means mounted on the front of the vehicle. The device as shown is a relatively flat plate with a plurality of teeth extending parallel to the direction of vehicle travel and arms which extend outward from each side and the middle of the device to provide structure and strengthen the teeth along which they are positioned. Such a device when mounted on the front of a Sherman tank was fully capable of pushing through the type of hedgerow found in the European countryside and provided a quick and easy means to breach this type of obstacle. However, the device was not designed to level or otherwise dress the debris created by the device and the result was a path that was difficult for the infantry to follow.

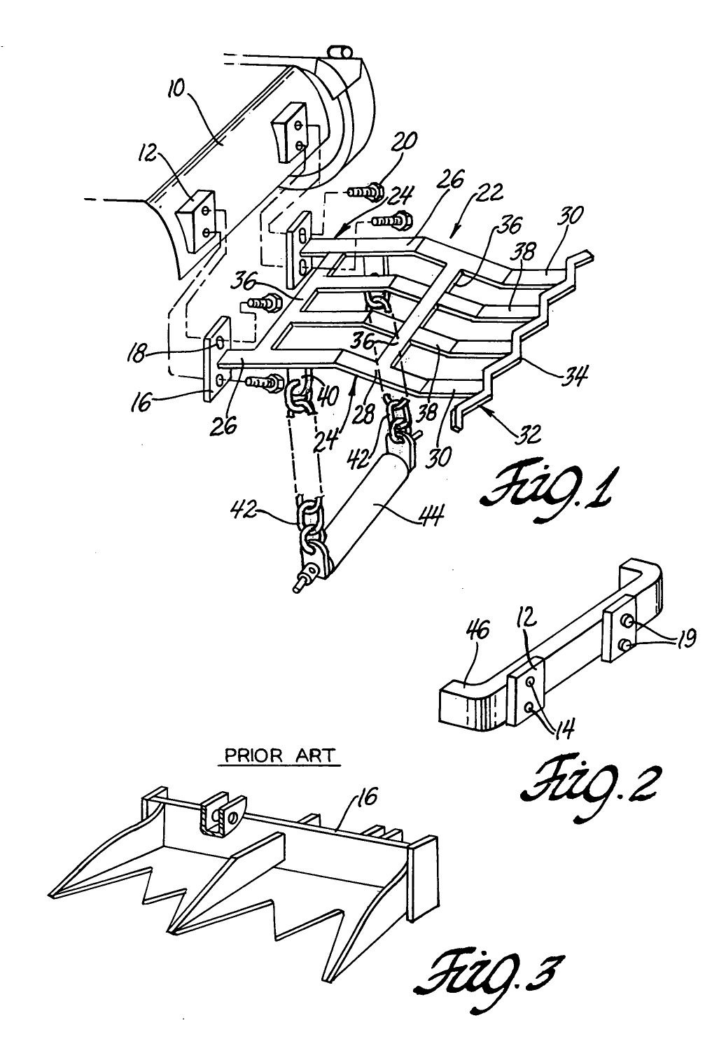

Turning to FIG. 1, the front portion of a tracked combat vehicle 10 is shown with a pair of mounting bosses, 12 containing threaded apertures 14, mounted on the front portion of the vehicle. Since both combat and tactical vehicles used by the military require substantial ground clearance to avoid becoming mired or damaged when moving cross-country, the bosses 12 will be mounted at a substantial distance above the terrain (not shown) the vehicle 10 is traversing. As shown, a pair of brackets 16 having corresponding apertures 18 suitable for receiving threaded fasteners 20 is provided for attaching a hedgerow breacher generally 22 to the mounting bosses 12 on vehicle 10. Extending outward from the brackets is a pair of arms 24. As shown, each arm 24 has a first section 26 attached to the bracket 16 such as by welding the first section to the bracket. The first section 26 extends perpendicular to the face of the bracket 16 and substantially parallel to the terrain over which the vehicle is moving. The first section 26 has a second end distal the end attached to the brackets, the distal end being attached to a second section 28 of the arm 24, which extends at an oblique angle to the first section 26 so that the second section 28 depends downwardly towards the ambient terrain. At the end of the second section 28 opposite the first section 26, a third section 30 is mounted at an oblique angle to the second section 28 similar to the angle between the first and second sections so the third section 30 extends outwardly parallel to the terrain.

At the end of the third section 30, a dentate cutting bar 32 having a plurality of teeth 34 is attached rigidly across the arms 24. The result is a cutting device disposed at a distance from the vehicle, which will remove brush, small trees, and rocks.

As shown in the drawing, the hedge-breaching device of this invention can be constructed with additional structural members designed to increase rigidity and provide stability. The device as shown has two reinforcement bars 36 or members that are disposed perpendicular to and between the first and second sections of the arms 24. Also shown are two additional reinforcement structures 38 or members shaped similarly to the arms 24. The reinforcement arms 38 are disposed between the bracket arms 24, to provide additional rigidity and are attached to the other rigidifying members 36. The result is a large open mesh arrangement. This type of structure with its openness allows brush and shrubs that are cut, and rocks that are dislodged to flow over the cutting bar and through the openings between the various members. The second sections 28 of the bracket arms 24 and reinforcement arms 38 form a ramp structure that will resist the upward motion of debris as it leaves the relatively flat surface of the third sections and cutting bar. This serves to keep the load on the third sections from building up and the resulting debris will be forced though the openings between the arms in furrows. Thus, rather than merely pushing or crushing the debris it will be moved and channeled to a semblance of uniformly. The resulting sized and furrowed debris will be more amenable to treatment by the leveling mechanism, described hereinafter.

The hedge-clearing device as shown has a pair of bosses 40 mounted on and extending downward towards the terrain from the first or upper section 26 of the arms 24. As shown, two link chains 42 extend or hang downward from the bosses 40 to a point close to the ground. On the ends of the chain 42 opposite the bosses 40, a heavy roller 44 is rotatably mounted on the ends of the chains closest to the ground. The roller 44 will contact debris which has passes through the mesh structure of the cutting bar and will level the resulting furrowed material into a path more amenable to traverse by individuals on foot. This will be particularly good for soldiers who are generally carrying substantial additional weight in the form of equipment and supplies.

FIG. 2 shows a bumper 12 which can be attached or would be attached to a tactical vehicle such as a truck with bosses similar to those shown on the combat vehicle of FIG. 1. The device of this invention mounts to such a truck in the same manner as it would be mounted on a combat vehicle.

Various alterations and modifications will become apparent to those skilled in the art without departing from the scope and spear this invention and is understood that this invention is limited only by the appended claims.

What is claimed is:

1. A hedge breaching device for use with a military vehicle including:
a plurality of brackets adapted to be fastened to complimentary attachment points on the front of the vehicle;
a plurality of spaced arms equal in number to the number of brackets, each of said arms having one end firmly attached to one of said brackets extending outward from said vehicle, said arms having a first section extending substantially parallel to the terrain over which the vehicle is moving, the arms having a second section attached at the end of the arm distal the bracket, said second section being disposed at an oblique angle to the first section with the end of the second section distal the first section being nearer the terrain over which the vehicle is traversing, and a third section attached to the lower end of the second section extending outward from the vehicle substantially parallel to the terrain over which the vehicle is traversing;
a dentate cutting bar connected to said arms said cutting bar having a plurality of sharpened teeth extending outward there from approximately parallel to the terrain being traversed; and
a leveling roller suspended from the first arm section, said leveling roller being disposed between said dentate cutting bar and said vehicle, the leveling roller being disposed at a height within the few inches of the terrain;
whereby when the dentate cutting bar has cut brush, the roller will flatten and compact the resulting debris to allow easier traverse by persons on foot.

2. the hedge breaching device of claim 1 having a plurality of reinforcement bars perpendicularly disposed between the arms and connected thereto to form an open mesh structure.
